(19) United States
(12) Patent Application Publication
(10) Pub. No.: US 2016/0127291 A1
(43) Pub. Date: May 5, 2016

(54) ANONYMOUS MOBILE GROUP COMMUNICATIONS

(71) Applicants: Bobby Kassab, Spring Valley, CA (US); Michael Rzeznik, St. Louis, MO (US)

(72) Inventors: Bobby Kassab, Spring Valley, CA (US); Michael Rzeznik, St. Louis, MO (US)

(73) Assignee: Group Easy, Inc.

(21) Appl. No.: 14/529,222

(22) Filed: Oct. 31, 2014

(51) Int. Cl. H04L 12/58; H04W 4/08; H04L 29/08; H04W 4/12

(52) U.S. Cl. CPC H04L 51/14; H04W 4/12; H04W 4/08; H04L 67/141

(57) ABSTRACT

A text-notification application for iOS and Android devices that facilitates broadcasting group messages for any size group, for any purpose, without requiring users to disclose email or cell phone contact information. Users can configure their own group channels to send and receive messages anonymously.

### CROSS-REFERENCE TO RELATED APPLICATION

This application claims the benefit of priority under USC §119(e) of provisional application No. 61/903,927, filed Nov. 13, 2013, entitled “A Process, method, and description for cross-platform (Android, iOS, etc) mobile app to allow people to opt-in for instant and anonymous group text communications with real-time alerts (via push notifications) over a customizable and cloud-virtualized “channel” without having to know/share/disclose a user's mobile phone or email address of anyone in the group”, hereby incorporated by reference herein.

### BACKGROUND OF THE INVENTION

I. Field of the Invention

The present disclosure relates generally to telecommunications. More particularly, it relates to wireless communication and devices, especially wireless devices capable of messaging (such as short messaging system (SMS) messaging, and multi-media system (MMS) messaging) and voice communication.

II. Description of the Prior Art

Wireless communications in the form of cellular phones and their supporting communications network have led to changes in the ways that people communicate with one another. For example, SMS transport is a service commonly available on mobile devices for the purpose of sending short messages between such mobile devices. This service is commonly referred to as “text messaging”. Typically, the messages comprise a few characters of text, the precise number depending on a particular encoding scheme used by the SMS implementation. Such conventional messaging technologies permit all parties (i.e. sender and recipient(s)) to a text message to specifically identify an originating party (e.g. device, web page, etc.) upon which the text message has been transmitted, and any recipient party (e.g. device, web page, etc.) upon which the text message is received. More particularly, conventional messaging technologies permit each party interacting via messaging to obtain identification credentials (e.g. IP addresses, mobile numbers, etc.) for every other party interacting therewith.

Another example of such wireless communications is the so-called Common Short Code (CSC). A CSC is a short code which is common across many wireless service providers in the United States. It is basically the inter-carrier for mobile applications. All CSCs are 5 or 6 digits in length (as compared to a 10 digit telephone number) and can be either random or select. A short code is a number to which an SMS or text message can be sent. A short code may be specific to one mobile operator or “common” and supported by all major mobile operators. In its simplest form, a CSC allows a company to effectively market and communicate with individuals; and also allows those individuals to engage and interact with a brand. For example, CSCs allow consumers to interact and communicate by sending a text message to a company's mobile application that may include voting, polling, gaming, coupons, and payments, among other applications. By way of example, a retailer that desires a personal cell phone number of a customer, might solicit that customer's text “Jack” (or something else) to 22343 (or some other number) for a coupon. While the CSC system may be advantageous under certain circumstances, one major disadvantage of the system is the costs involved.

In many group situations, individuals want to be instantly alerted/notified on their mobile device. Such situations may include, for example, emergencies, important announcements, instant coupons, events, etc. However, in many of these same group situations, many individuals would prefer to remain anonymous and maintain the privacy of their personal contact information.

Email and so-called Social networks (e.g. FaceBook, Twitter and Instagram) are not a valid solution. Such networks tend to be checked leisurely and are typically filled with non-urgent content. Additionally, millions of mobile phone users still refuse to adopt social networking as they deem it childish, unprofessional and/or distracting. Furthermore, there options still require signing in, registering, giving out personal contact information, etc. Accordingly, whether the user of a mobile device is utilizing email, a social network, SMS, CSC, or any other messaging system, anonymity is not possible.

There are, of course, numerous reasons in which users may want to keep their identity unknown during text messaging. For the one doing the transmitting, a user may desire to remain anonymous during texting of opinion, suggestion, complaint, or perhaps even reporting a crime. Additionally, a user may desire to transmit an anonymous donation or other charity. Furthermore, a business may desire to send a message containing an anonymous reminder, advertisement, discount, coupon, etc. Turning to the receiving side, it is often desirable to receive communications and other information without providing or disclosing user identification (e.g. cellular telephone number, email address, etc.). In other words, people want to receive the communication but do not want to sacrifice their personal information. The only way to currently remain somewhat anonymous during text messaging is to use a complicated system that intercepts the message (e.g. SMS, email, etc.) following message transmission, and substituting an anonymous/fake source address for the real source address originally supplied therein. This is accomplished through the use of an anonymous communication module that performs intercept and address substitution. However, this system needs initial personal identifiers to initiate communication between users.

There remains no system that can anonymously broadcast and receive such communications without the necessity of providing identifying personal information. Accordingly, there exists a need for such a system to both eliminate the necessity of obtaining such information and thereby creating a distribution list on the sending side; and to eliminate the necessity of providing identification information on the receiving side.

It is a general object of this disclosure to provide systems, methods and apparatuses for addressing the deficiencies of the current practices regarding issues associated with mobile group communications and the like.

It is a general object of this disclosure to provide systems, methods and apparatuses that are simple, easy to use and familiar for mobile group communications.

It is another general object of this disclosure to provide cost effective systems, methods and apparatuses in mobile group communications.

It is more specific object of this disclosure to provide systems, methods and apparatuses in mobile group communications while maintaining privacy and anonymity.

It is another more specific object of this disclosure to provide systems, methods and apparatuses for mass group messaging in mobile group communications while eliminating distribution lists.

It is yet another specific object of this disclosure to provide systems, methods and apparatuses in mobile group communications for efficient mobile advertising.

A further object of this disclosure is to provide systems, methods and apparatuses in mobile group communications to effectively disseminate important or urgent information to group members.

Yet a further object of this disclosure is to provide systems, methods and apparatuses that allow customization of messages and message channels in mobile group communications.

Yet another further object of this disclosure is to provide systems, methods and apparatuses that allow users to choose to receive messages by joining message channels in mobile group communications.

A further object of this disclosure is to provide anonymity and group broadcasting capabilities that replace the archaic SMS short code technology.

These and other objects, features and advantages of this disclosure will be clearly understood through a consideration of the following detailed description.

### SUMMARY OF THE INVENTION

According to an embodiment of the present disclosure, there is provided a system for establishing communication between a transmitter and one or more personal communication devices where the transmitter does not need to know the address or any other identifying indicia of any of the personal communication devices, the system includes a server to establish a designated communication channel and multiple personal communication devices for transmitting and receiving information to the channel, and application on each of the personal communication devices that permits the selection of the channel and enables reception of messages transmitted such that the personal communication devices can receive and review messages transmitted to the channel without the transmitter having to know any identifying indicia of the user of any device.

There is also provided a mobile group communications system for use with personal communication devices and a network, the system having a server capable of receiving and transmitting communications through the network and a database containing information representing each of a plurality of personal communication devices, a first user personal communication device establishing a virtual communication channel within the system for broadcasting messages and a second user personal communication device joining the channel without requiring user contact information whereby the first user broadcasts a message through the channel and the second user receives the message.

There is also provided a mobile group communications application for use with personal communication devices and a network, the application having unique code-words associated with each personal communication device and a server capable of differentiating multiple users of the application by the code-words, a database associating the code-word with a channel of communication and having a distribution list of multiple code-words for each channel whereby when a personal communication device sends a message on a channel a copy of the message is sent by the server through the network to each code-word on the list.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is illustrative of a communication network environment in which preferred embodiments of the anonymous mobile group communications system of the present disclosure are implemented.

FIG. 2 is a simplified logistic diagram of the anonymous mobile group communications system of the present disclosure.

FIG. 3 is an application flow diagram of the anonymous mobile group communications system of the present disclosure.

FIG. 4 is a series of personal communication device (PCD) screen shots illustrating introductory information of the anonymous mobile group communications system of the present disclosure after initial application download.

FIG. 5 is a PCD screen shot illustrating a home screen of the anonymous mobile group communications system of the present disclosure.

FIG. 6a is a series of PCD screen shots illustrating the creation of a channel within the anonymous mobile group communications system of the present disclosure.

FIG. 6b is a series of PCD screen shots illustrating the creation of a channel within the anonymous mobile group communications system of the present disclosure.

FIG. 7 is a series of PCD screen shots illustrating a process of selecting a channel icon.

FIG. 8 is a PCD screen shot illustrating a quick response (QR) code for a selected channel.

FIG. 9 is a PCD screen shot illustrating initiation of a newly created channel.

FIG. 10 is a PCD screen shot illustrating a process of sharing a channel.

FIG. 11a is a series of PCD screen shots illustrating channel settings.

FIG. 11b is a series of PCD screen shots illustrating channel settings.

FIG. 12 is a series of PCD screen shots illustrating private communications between users of the anonymous mobile group communications system of the present disclosure.

FIG. 13 is a series of PCD screen shots illustrating the joining of a channel within the anonymous mobile group communications system of the present disclosure.

FIG. 14 is a PCD screen shot illustrating the scan of the QR code for a selected channel.

FIG. 15 is a PCD screen shot illustrating information regarding a selected channel.

FIG. 16 is a series of PCD screen shots illustrating a process of user authorization.

FIG. 17 is a PCD screen shot illustrating general information about the anonymous mobile group communications system of the present disclosure.

FIGS. 18a-c illustrate the backend logic flow diagram of the coding of the anonymous mobile group communications system of the present disclosure.

### DESCRIPTION OF THE PREFERRED EMBODIMENTS

The following description of the preferred embodiments is merely exemplary in nature and is in no way intended to limit the disclosure, its application or use. These exemplars are merely used to better describe the true spirit and scope of the present disclosure.

The present anonymous mobile group communications system allows users to easily send and/or receive urgent or important information or updates through group messages via PCDs. Such PCDs may include, but are not limited to, smartphones, tablets, personal computers, other computers, and the like. The group message may alert (i.e. sound, vibrate, etc.) in the same manner new messages alert users in the conventional text messaging environment. In general, those who want to broadcast (i.e. Broadcasters) their messages to a group receive a group identification or channel number from the system administrator or host. The Broadcaster then shares the channel number with the intended group of those whom may want to receive or listen (i.e. Listeners) to the messages. In its simplest form, Listeners may tune-in to any channel they want to receive messages from, much like a conventional radio. In fact, all Users are by default anonymous unless they choose not to be.

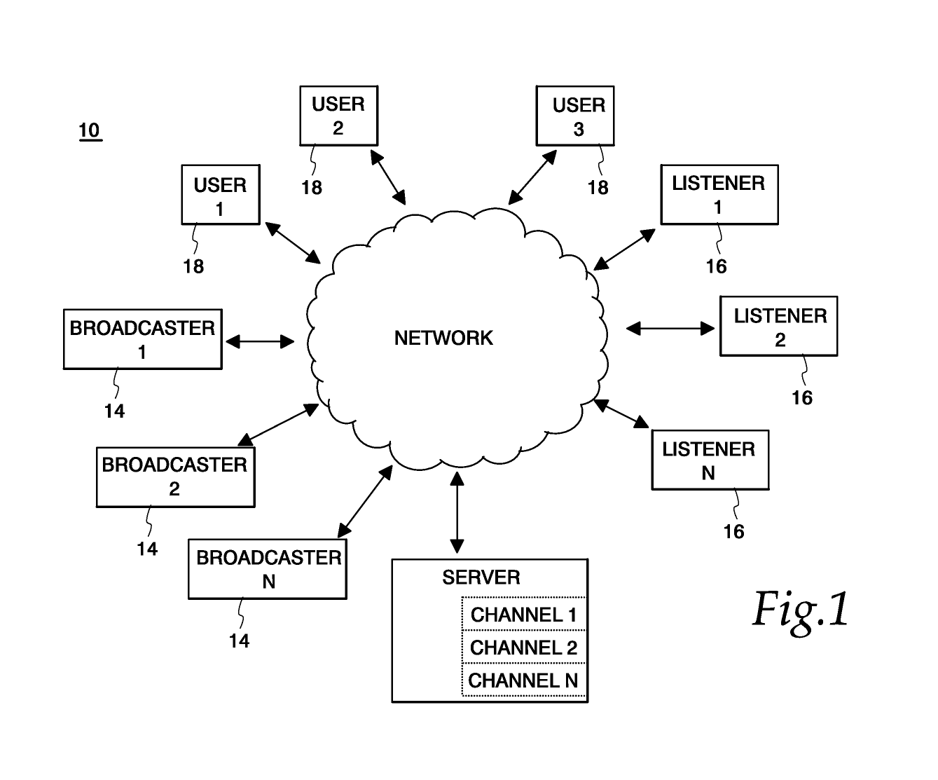

FIG. 1 is a schematic overview diagram of the communication network and computing environment in which the preferred embodiments are implemented. The preferred mobile group communication system 10 includes one or more servers 12, Broadcasters 14, Listeners 16 and other users 18, linked together using a network 20, such as a cellular network. The network 20 may be comprised of any network known in the art for mobile communications. Alternatively, there may be separate and different networks between components. Further, because the preferred embodiment of the network 20 is a cellular network, there can be a huge number of participants, including Broadcasters (Broadcasterₙ), Listeners (Listenerₙ), other users (Userₙ), together with the Channels (Channelₙ) they may be utilizing, simultaneously.

The servers 12 include database and database interfaces known in the art. The server 12, through its database, keeps current, accurate information about the users of the service, e.g., Broadcasters and Listeners, and their respective Channels 22. Information is preferably stored in a non-volatile storage system, such as one or more hard disk drives, used by the server 12 for storage. The server may load data from the storage system into volatile memory when processing. It is envisioned that the management system 10 will utilize multiple servers 12 at different physical locations to help ensure safety and security. It is further envisioned that the management system 10 may utilize off-site remote server services, such as a dynamic virtual private server (e.g. cloud server). In any event, the server 12 may comprise one or more separate computer systems to run the different components of the mobile group communication system 10. Further, in accordance with known technology, the management system 10 is enabled to create virtual channels 22 to enable unidirectional and/or bidirectional communication between, for example, Broadcasters and Listeners using standard protocols. For example, the server can create a virtual channel data path for mobile transmitting and mobile receiving devices to utilize to permit a path of communication between the transmitting and receiving devices. Accordingly, the server is capable of receiving and transmitting communications with the databases and otherwise.

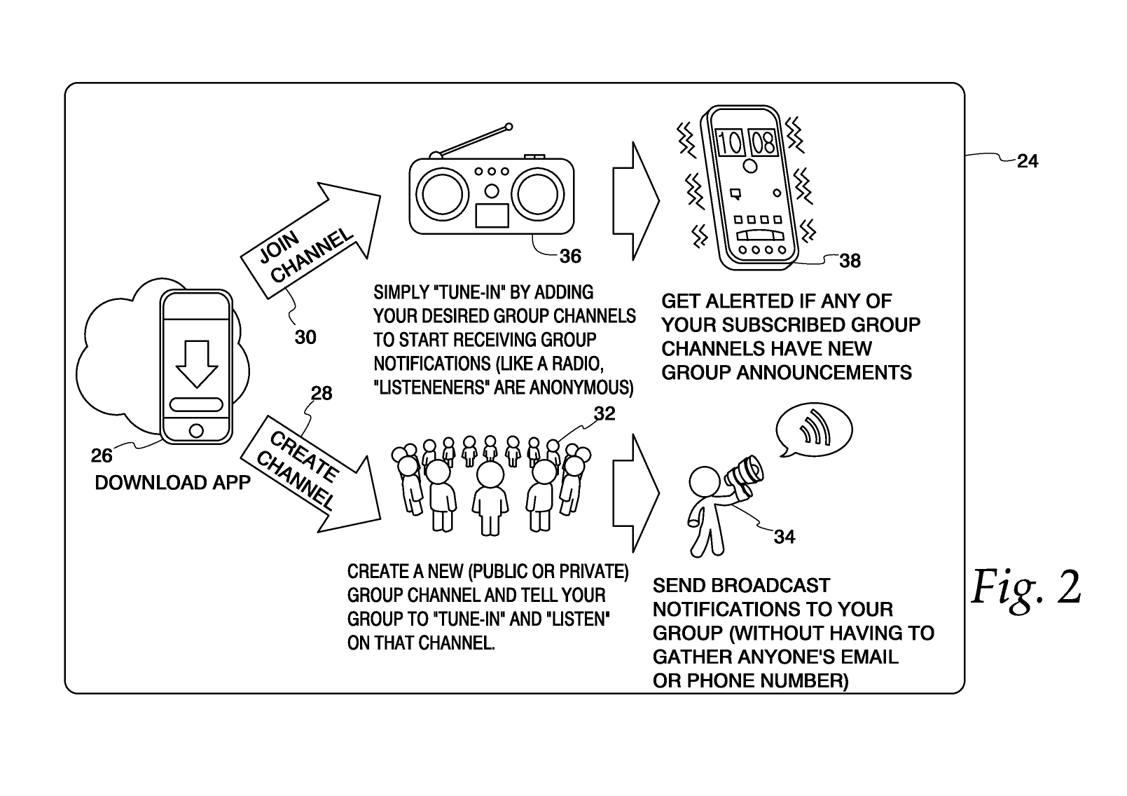

FIG. 2 is a simplified logistic flow diagram 24 of the mobile group communications system of the present disclosure. In particular, once the system software and code (the application or so-called “app”) is downloaded and installed on the user PCD 26, the new user either creates 28 a channel or joins 30 an existing channel. If the new user is creating a channel, he initializes the channel settings 32 and can then send messages 34 to his group. If the new user is joining a channel, he adds the desired group 36 and gets alerted 38 of any new messages.

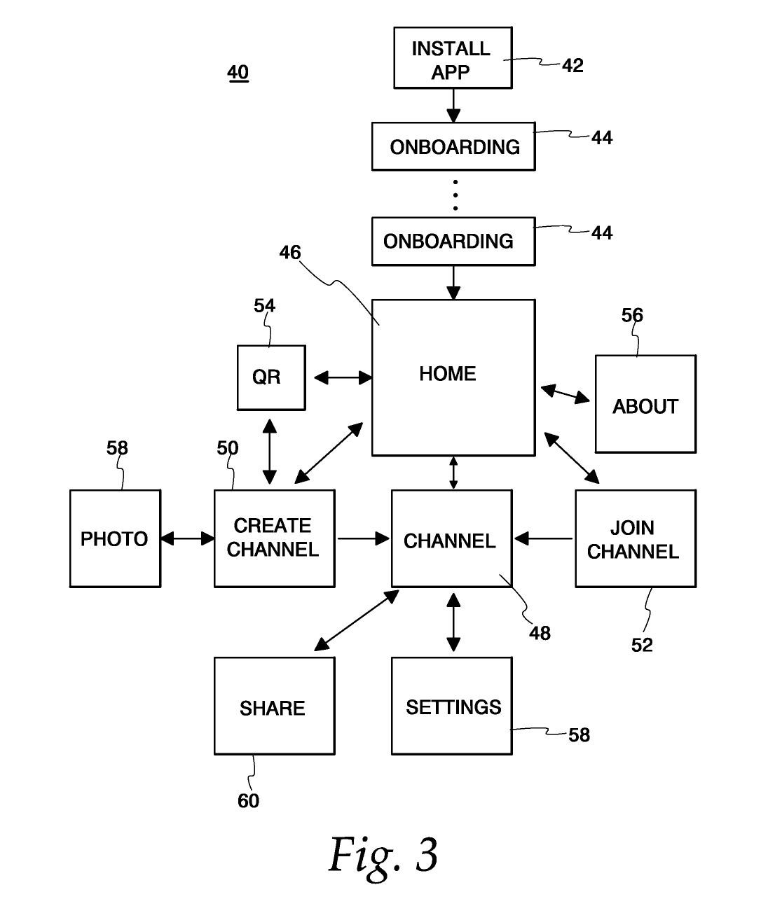

Turning now to FIG. 3, the app flow diagram 40 of the anonymous mobile group communications system of the present disclosure will be more particularly described. Upon app install 42, there are preferrably numerous onboarding or app introductory 44 PCD screens that introduce the new user to the application before negotiating the user to the home screen 46. From the home screen 46, the user can go to a channel 48, create a channel 50, join a channel 52, scan a QR code 54 and/or review information 56 about the app. From the create channel 50 screen the user can go to the home screen 46, incorporate a photo or icon 58, go directly to a channel 48 and scan a QR code 54. From the join channel 52 screen the user can go to the home screen 46 or go directly to a channel 48. Finally, from the channel screen 48 the user can go to the home screen 46, apply particular channel settings 58 or share 60 the channel.

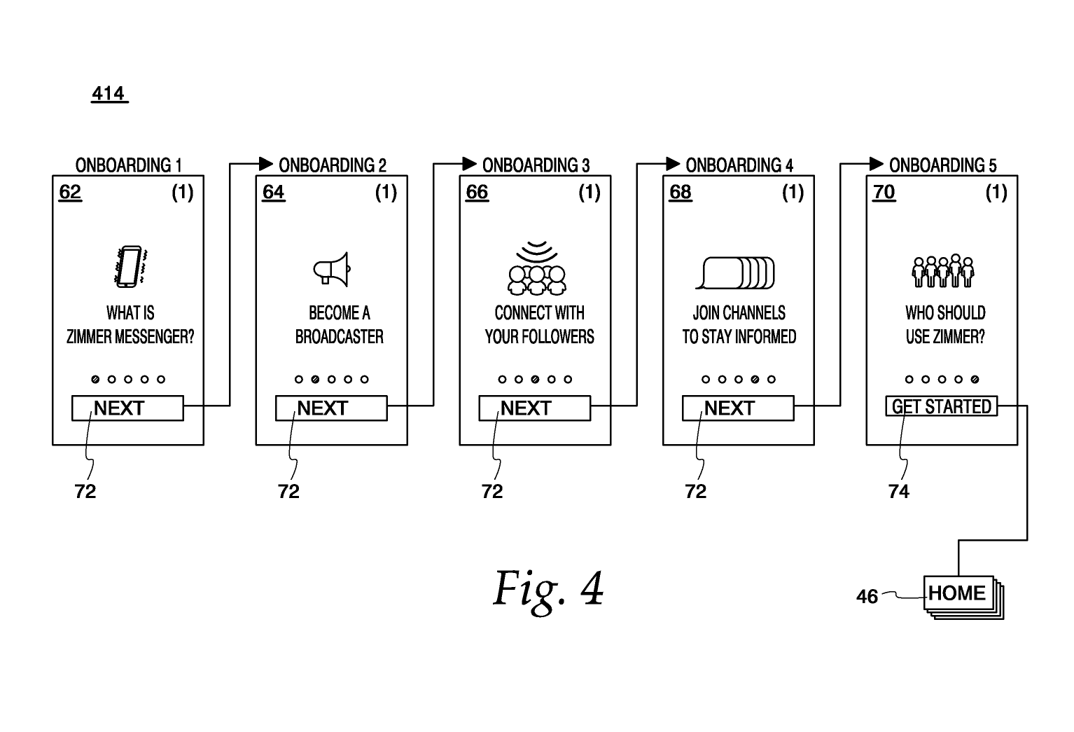

FIG. 4 is a series of PCD screen shots illustrating introductory information (onboarding 44) of the anonymous mobile group communications system of the present disclosure after initial app download. Such information may include, for example, i) broadcast text notifications to any size group without knowing recipients phone number or email address—no social network account required; ii) invite others to join your customized channel—its free and anonymous—no login or registration required 64; iii) instantly notify your group of any urgent notifications via text message 66; iv) send and receive messages from favorite groups and/or organizations, anonymously; and v) anyone (businesses, clubs, teams, retailers, individuals, etc.) who wants to communicate or stay in touch can take advantage of this app. Basically, the application provides a new way of group message communications. It allows users to anonymously join any number of desired group channels without logging in, registering, or sharing their contact information with anyone else on that channel. It allows users to easily start their own group channel and relieves them from manually collecting or requiring anyone's cell phone number or email address to communicate. Channels can be used for broadcasting alerts, notifications, or any type of messages. They can be made public or private, and can be used for one-way or two-way broadcast communicating. Channels can be added, deleted, silenced or de-activated at any time. Once the user scrolls through these onboarding screens, by selecting “Next” 72, they are prompted to select “Get Started” 74, which brings them to the app home screen 46.

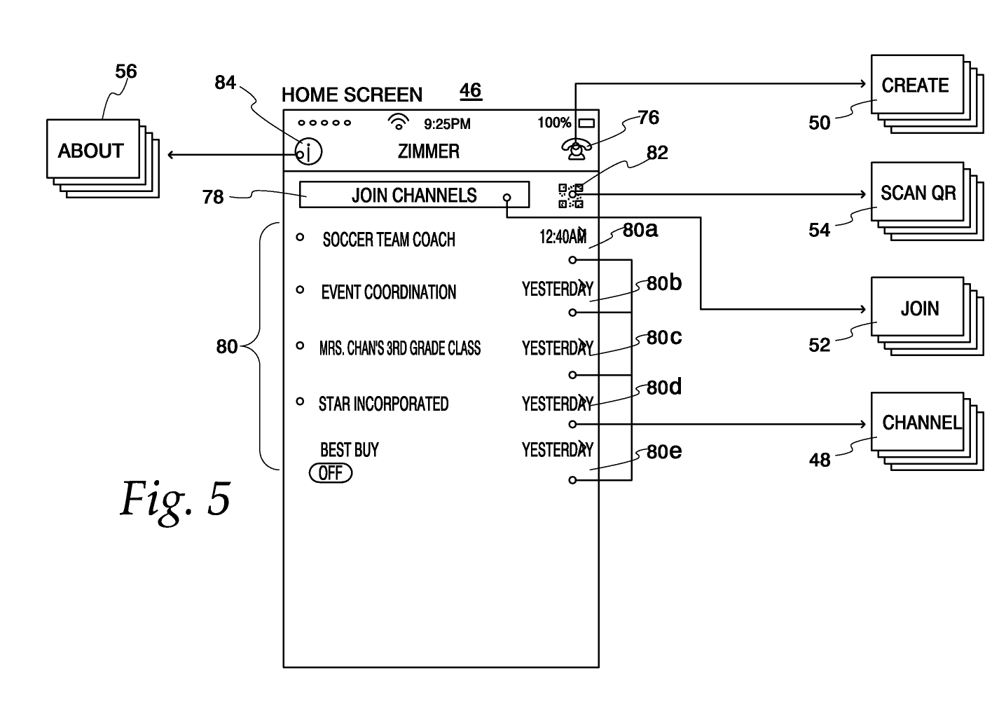

The application home screen 46, as illustrated in FIG. 5, is typically the main screen used, and allows the user to navigate through many of the features/functions of the app. More particularly, if the user desires to create 50 a new channel, he selects the create icon 76. If the user desires to join 52 an existing channel, he selects the join channel icon 78. The channels that the user is already associated with are also listed 80 the home screen 46. Any channel (80a-80e) listed here may be selected, and the user will navigate directly to the desired channel. The home screen 46 further includes icons 82,84 to navigate to Scan QR 54 and About 56, respectively.

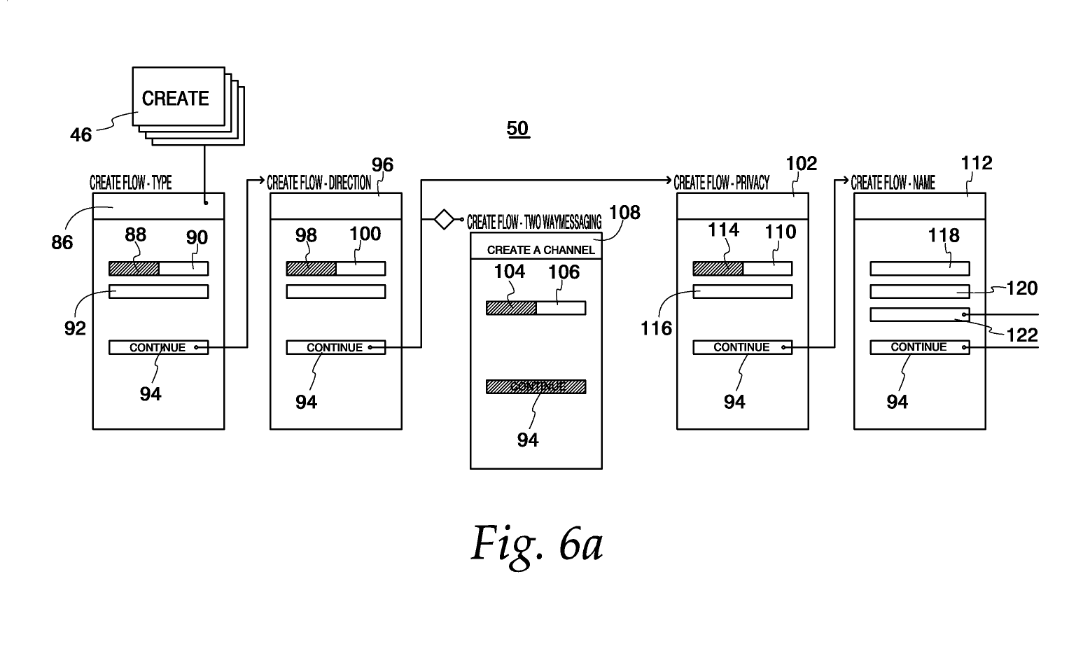

The process by which a channel is created 50 will now be more particularly described as illustrated in FIGS. 6a and 6b. At the initial screen 86, the user (Broadcaster) selects whether he wants to create a private 88 or a public 90 channel. A private channel 88 is a channel that requires a password and only users who know the password can add the channel to their respective channel list and join. If the Broadcaster desires to create his channel as a private channel, he will be prompted to create a password 92 for his Listeners to be able to join. If the Broadcaster creates a public channel, the password 92 select option is inoperable. Additionally, the password can be changed (or even eliminated, thereby making it a “public” channel) by the Broadcaster at any time via the settings menu.

In any event, once the channel type has been selected, the Broadcaster selects “Continue” 94 and proceeds to the type of messaging screen 96. From here, the Broadcaster selects one way 98 or two way 100 messaging. One way 98 channels allow only the Broadcaster to send messages and the Listeners are only able to receive and not respond. Two way 100 channels allow the Listeners to respond and send messages. Should the Broadcaster choose a one way 98 channel he will proceed to the privacy screen 102 upon selecting Continue 94. Should the Broadcaster choose to create a two way 100 channel he will further be prompted to choose whether Listeners can respond only to the Broadcaster 104 or to everyone 106 Listening to the channel at the two way selection screen 108 before Continuing 94 to the privacy screen 102.

At the privacy screen 102, the Broadcaster next selects how he wants to appear to members of his group chat or channel. In particular, if he wants to remain anonymous, and simply be known as BROADCASTER, he selects the anonymous icon 110 and then Continue 94 will navigate him to the channel description screen 112. However, if he selects Usemame 114, he will need to create a Usemame 116 so that his followers will know him by his name. After which Continue 94 will navigate to the description screen 112. Once at the description screen, the Broadcaster can choose how he wants to display his channel to help users locate it. For example, channel name 118, and channel description 120 may be entered and a category 122 may be chosen. If the Broadcaster desires to choose a category, category screen 124 may provide any number of choices 126 (i.e. Retail, School, Sports, etc.) or simply “Other” 128. Once a category is selected, the Broadcaster is navigated back to the description screen 112, selects Continue 94 and moves on to the Add A Photo screen 130.

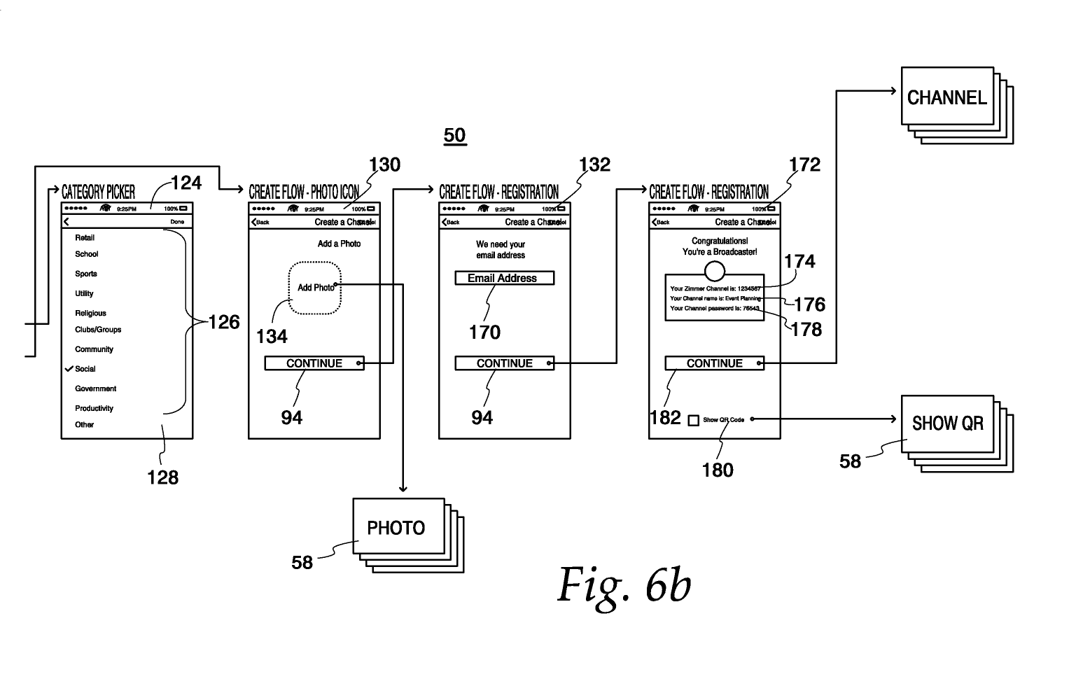

In the event the Broadcaster does not want to include a photo or other icon to display along with the channel information, he simply selects Continue 94 and moves on to the Registration screen 132. However, if the Broadcaster desires to include a photo/icon, the Add Photo icon 134 will navigate him to the process of selecting as illustrated by FIG. 7. The initial choice screen 136 provides the choices of either taking a new photo 138, choosing a photo 140 or canceling 142 back to the Add a photo screen 130. If he chooses to take a photo, he will be navigated to the take photo screen 144 wherein his PCD can take a photo 146 or cancel 148 back to the initial choice screen 136. After the photo has been taken, it can be cropped 150 in any manner used by the PCD and the Broadcaster can either use it 152 as the channel icon or retake 154 it. If he chooses to use it, flow goes back to the Add a photo screen 130 and Continues 94 to Registration 132. If he wants to Retake 154, then he is navigated back to the take photo screen 144.

Turning back to the initial choice screen 136 of FIG. 7, if the Broadcaster desires to Choose a Photo 140 from his PCD, he will be navigated to the particular photo collections 156 library of his PCD. The Broadcaster can then make a selection, camera roll 158, for example, wherein that particular selection screen 160 provides photos to be chosen. Once a photo is selected 162 it can be cropped 164 in any manner used by the PCD and the Broadcaster can either Choose it 166 and navigate back to the Add a photo screen 130 to Continue 94 to Registration, or he can cancel 168 back to the selection screen 160.

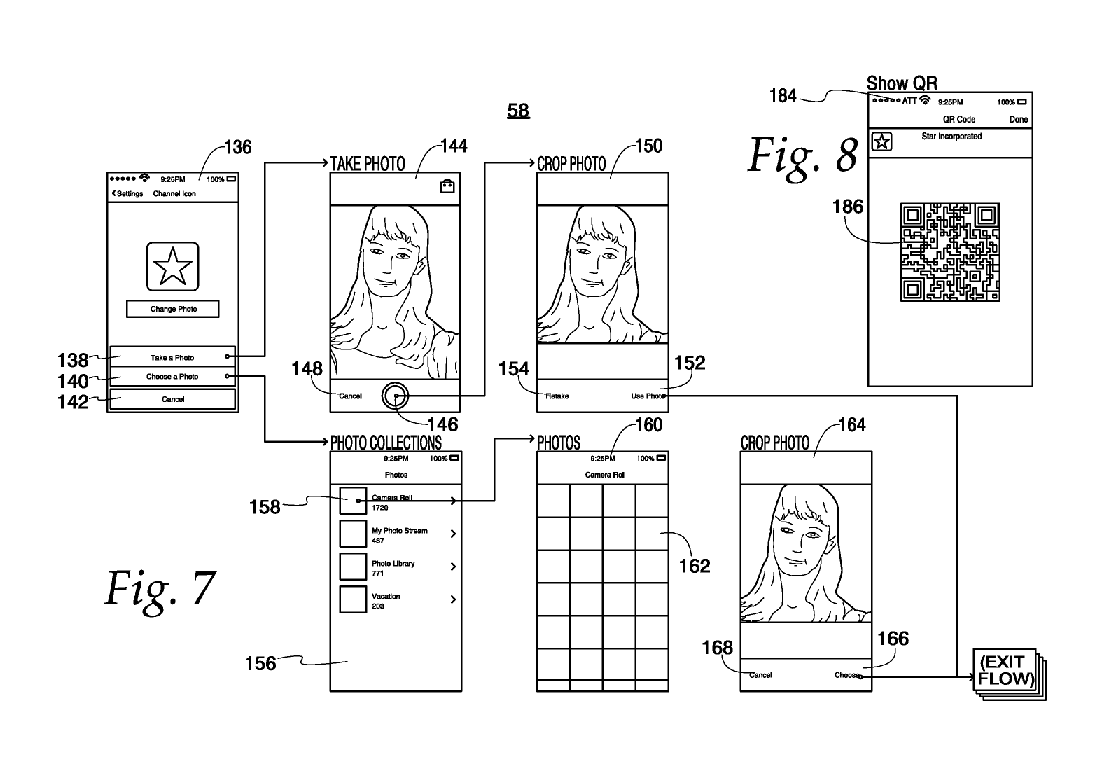

Once at the Registration screen 132, the Broadcaster simply needs to provide an email address 170 to the system administrator. This address will not be provided to the Listeners, but will be used only to maintain administrative privileges in the event that the Broadcaster switches PCDs. N other words, the Broadcaster would not be able to recover administrative privileges by simply rejoining the particular channel because his privileges would be limited to an ordinary user (Listener). The email address simply provides the system with the ability to promote the user's new PCD back to Broadcaster status for those channels in which he was the administrator. In any event, once registration is completed, Continue 94 navigates to the confirmation screen 172. At the confirmation screen the channel number 174, channel name 176 and channel password 178 (if applicable) are displayed. The Broadcaster can either select the Show QR Code icon 180 or the Start Broadcasting 182 icon. If he selects Show QR 180, then the QR Code screen 184 for the particular channel is presented, see FIG. 8. Anyone that has downloaded the app and wants information on the particular channel can then simply scan the code 186. If the Broadcaster selects the Start broadcasting icon 182 from the confirmation screen 172 he navigates to the newly created channel screen 188.

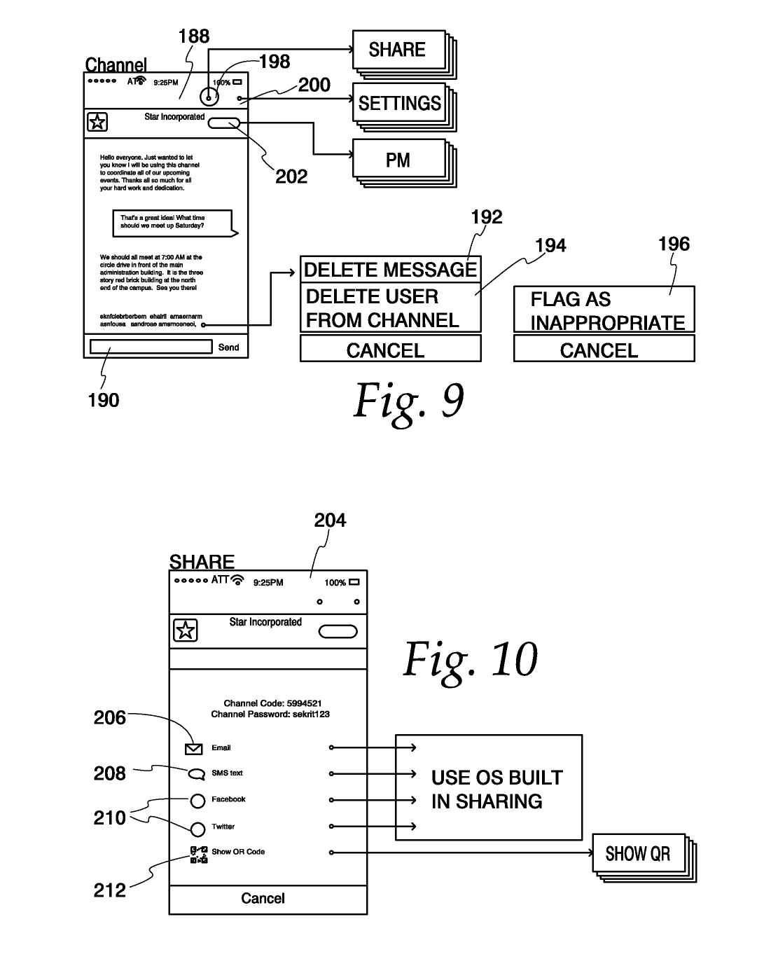

From the channel screen 188, FIG. 9, the Broadcaster can begin to send messages via the dialog box 190 to his Listeners. He is further capable of deleting 192 Listener responses (if any), deleting 194 a Listener from his channel and flagging 196 a response (if any). Further icons on the channel screen 188 may include sharing 198 the channel, channel settings 200 and private messaging 202 capabilities.

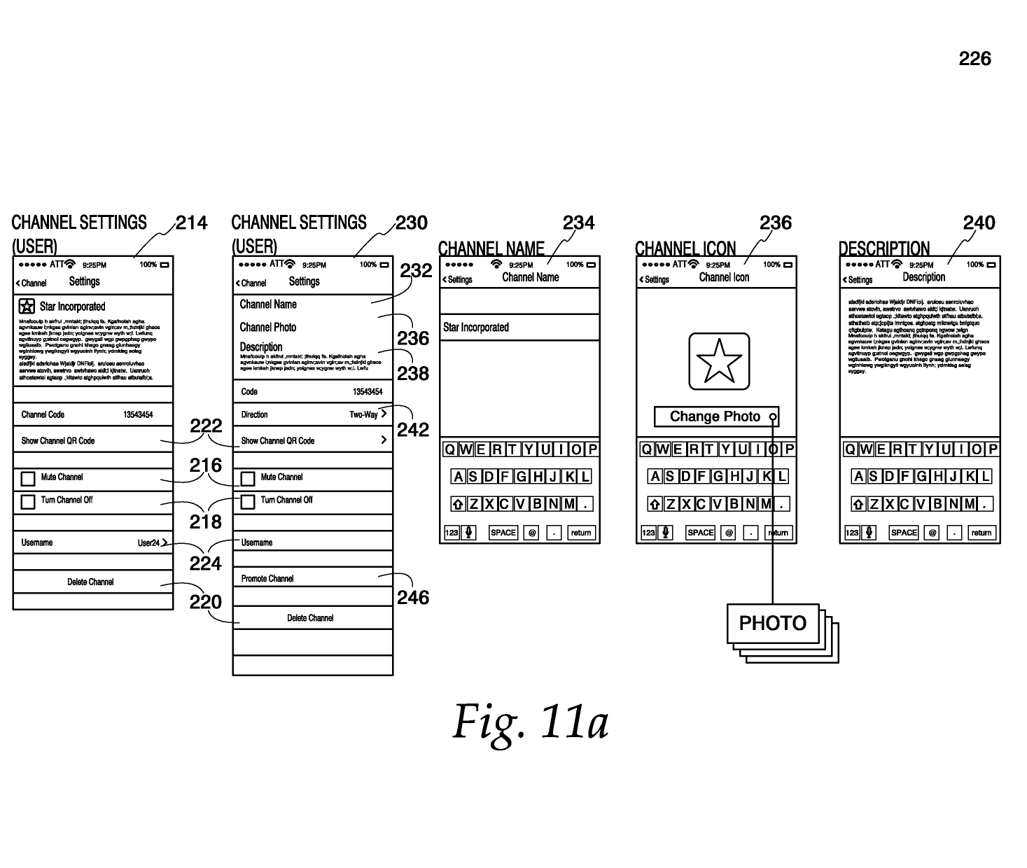

The process of sharing a channel is illustrated by the PCD screen 204 of FIG. 10. While it is up to the Broadcaster to spread the existence of his channel to his desired group of listeners via word of mouth, flyers, social networking, school announcements, etc., the app also provides ways to share. The Broadcaster can share his channel in numerous ways, including for example, email 206, SMS text 208, social media 210 or by showing the channel QR Code 212 (as previously discussed with respect to FIG. 8).

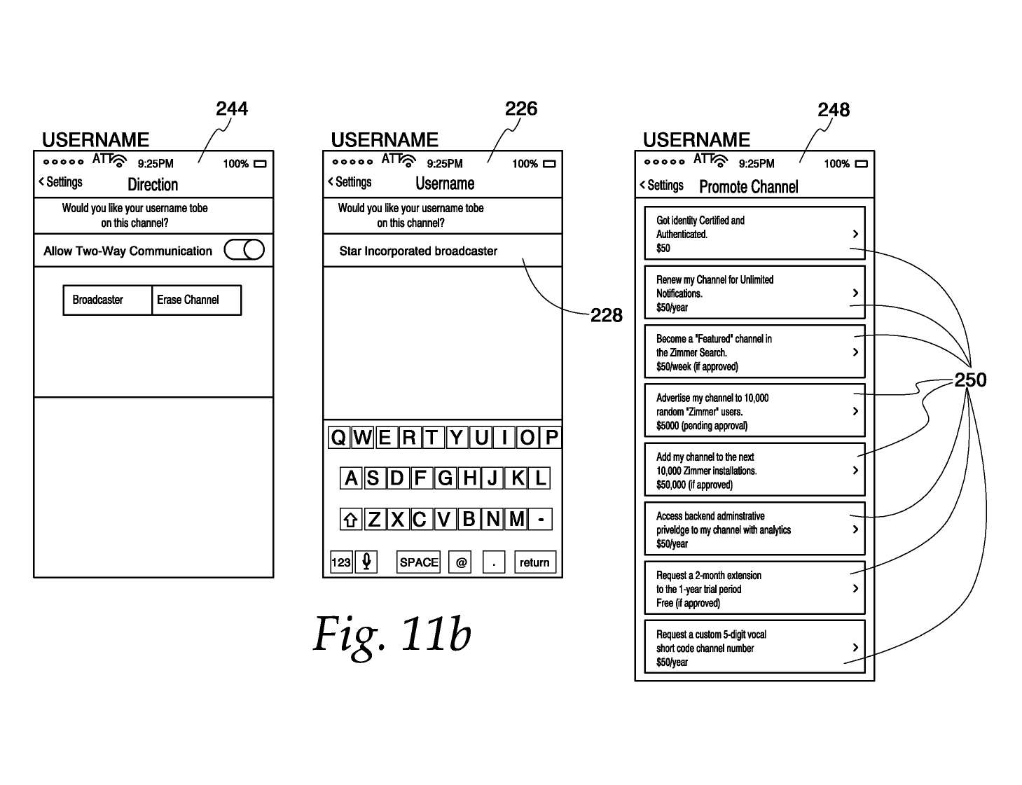

Referring back to FIG. 9, if the User, whether a Broadcaster or a Listener selects the setting icon 200 he is navigated to the channel settings process of FIGS. 11a and 11b. If the User is a Listener, the Listener settings screen 214 allows him to toggle the channel to Mute 216 the channel turn Off 218 the channel and even delete 220 the channel from his listing. Muting disables notifications and alerts, and Off stops all messages and updates. The Listener can also select to show the channel QR Code 222 (previously discussed FIG. 8) and/or select to change/create a Usemame 224. The Usemame screen 226 allows either a Broadcast or a Listener to enter text 228 to create.

When a Broadcaster selects the settings icon 200 from FIG. 9, he is directed to the Broadcaster settings screen 230. The Broadcaster settings screen 230 includes selections already described in the Listener settings screen 214; namely Mute 216, Off 218, Delete 220, QR Code 222 and Username 224; together with additional Broadcaster selections. The Broadcaster may desire to change some settings that he already provided, namely the channel name 232 where he would be directed to the channel name screen 234 for edits, the channel photo/icon 236 where he would be directed to the channel icon screen 236, the channel description 238 where he would be directed to the channel description screen 240, and the channel messaging direction 242 where he would be directed to the communication direction screen 244. The promote channel selection 246 brings the Broadcaster to the promotions screen 248 wherein he is presented with numerous options 250 by which to promote his channel. Such promotions will be administered through the backend of the system via the system administrator. These promotions may include, for example, becoming a featured channel, advertising the channel to random Users, adding the channel to the next number of application installations, and/or access to backend administrative data including analytics, etc.

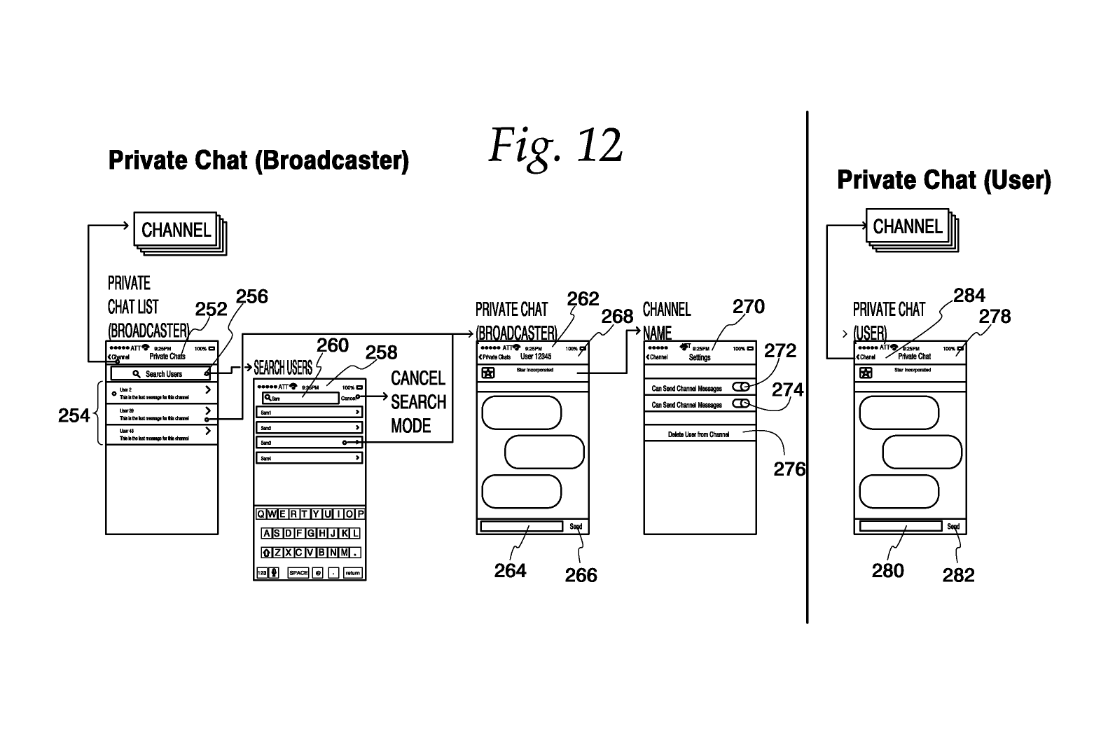

Turning back to the channel screen 188 of FIG. 9, if the Broadcaster selects the private messaging icon 202 he is directed to the private chat list screen 252, see FIG. 12. The chat list screen 252 displays a listing 254 of all the active users on the channel. The Broadcaster can then either scroll through the listing 254 and select the appropriate User to private message or select the search icon 256. The search icon will navigate the Broadcaster to the search screen 258 wherein he can enter the name in the text box 260. In any event, once the User is selected the private chat screen 262 opens and dialog begins. Just as with the typical text message, text is entered in the dialog box 264 and the send icon 266 is selected to send the message. The Broadcaster also has the option of changing settings via settings icon 268, which will bring him to the chat settings screen 270 where he can allow the User to send messages back to the Broadcaster or to the entire channel via respective toggle icons 272, 274. The user can also be deleted from the channel through the delete user selection 276.

Referring back to FIG. 9 once more, if the User is a Listener and he wants to private chat with the Broadcaster, the private chat icon 202 is selected and he is navigated to the Listener private chat screen 278 of FIG. 12. Again, just as with the typical text message, text is entered in the dialog box 280 and the send icon 282 is selected to send the message. When the Listener is done and wants to return to the channel, channel icon 284 is selected.

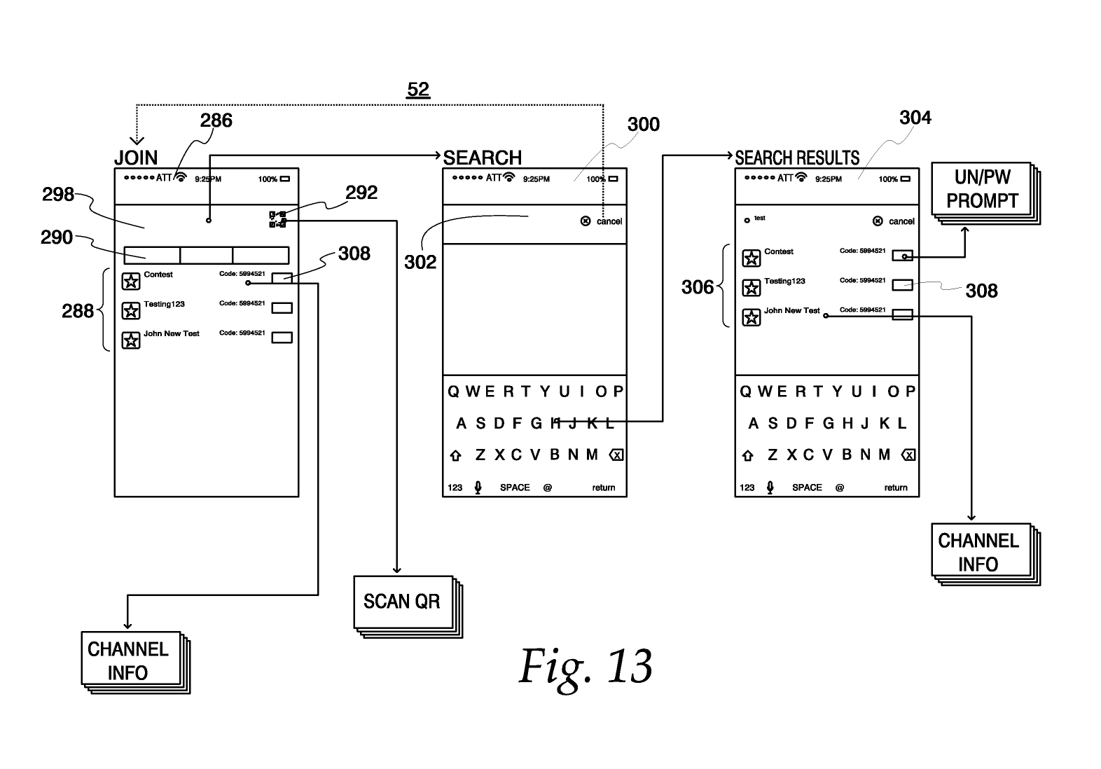

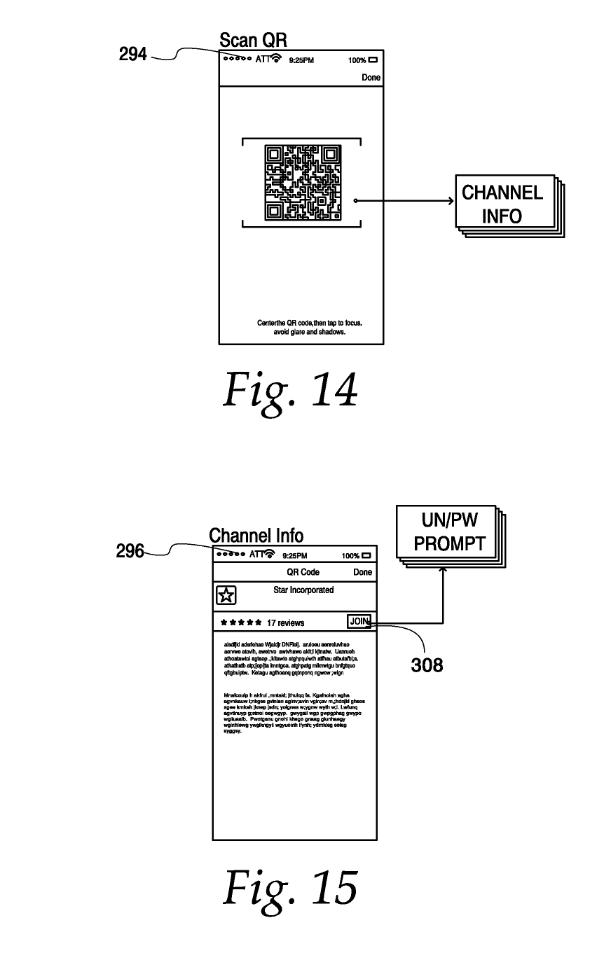

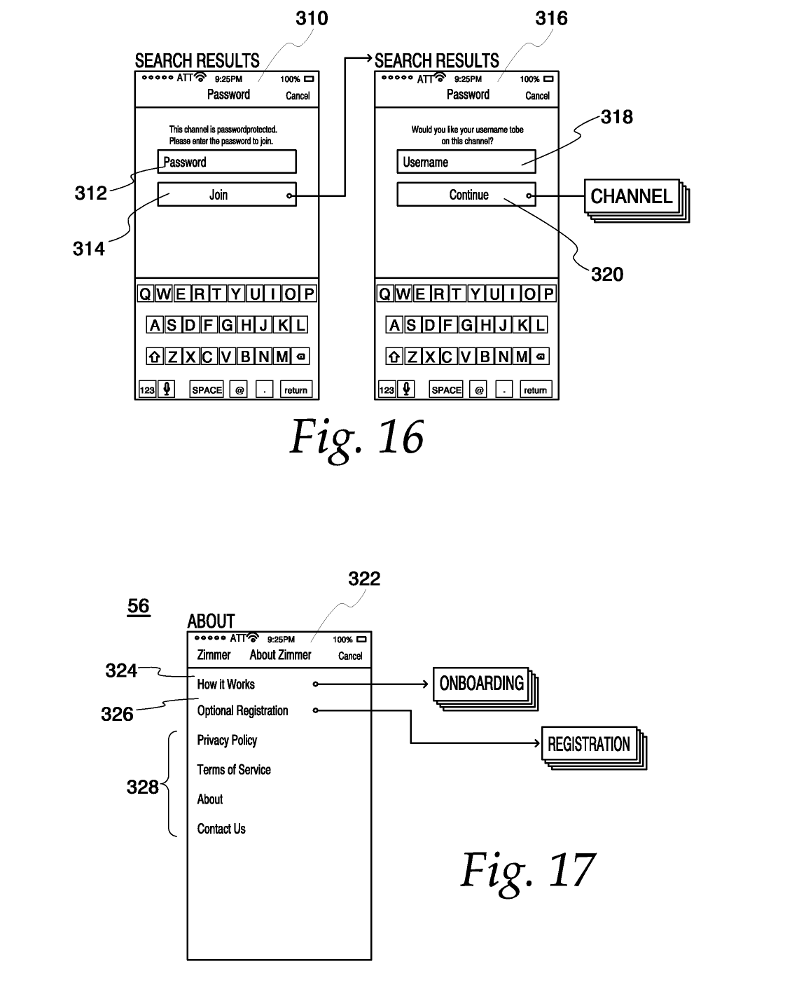

The application features of the present disclosure have thus far mostly been described as they relate to the User being a Broadcaster. The features relating to the User being a Listener are just as advantageous and will now be further described. Referring back to the home screen 46 of FIG. 5, when the User desires to join a channel via the join channel icon 78, he is navigated to the join channel screen 286 of FIG. 13. Channels may be listed 288 on the join channel screen 286 by any number of ways, be it Featured, Popular, New, etc.; a toggled selector 290 may further scroll through these or other categories. A channel may also be scanned via scan icon 292. This scanning can be accomplished both in the real world (e.g. display or decal near a point of sale) as well as being shown on another user's phone. If the user desired to scan a channel, the scan icon 292 will navigate him to the scan QR screen 294 of FIG. 14. Once a proper channel QR Code has been scanned, the channel information relating to that channel will be displayed via a channel information screen 296, see FIG. 15. Furthermore, the Listener can always simply join a channel upon the opening of a link that may have been shared via email, text and/or social media, etc.

Referring back to the join channel screen 286, the User may also search for a channel through the search selector 298. The search screen 300 then allows the User to enter text 302 and search for channels. Users can search by keyword, channel name, channel number, etc. A search results screen 304 lists the results 306 of the search.

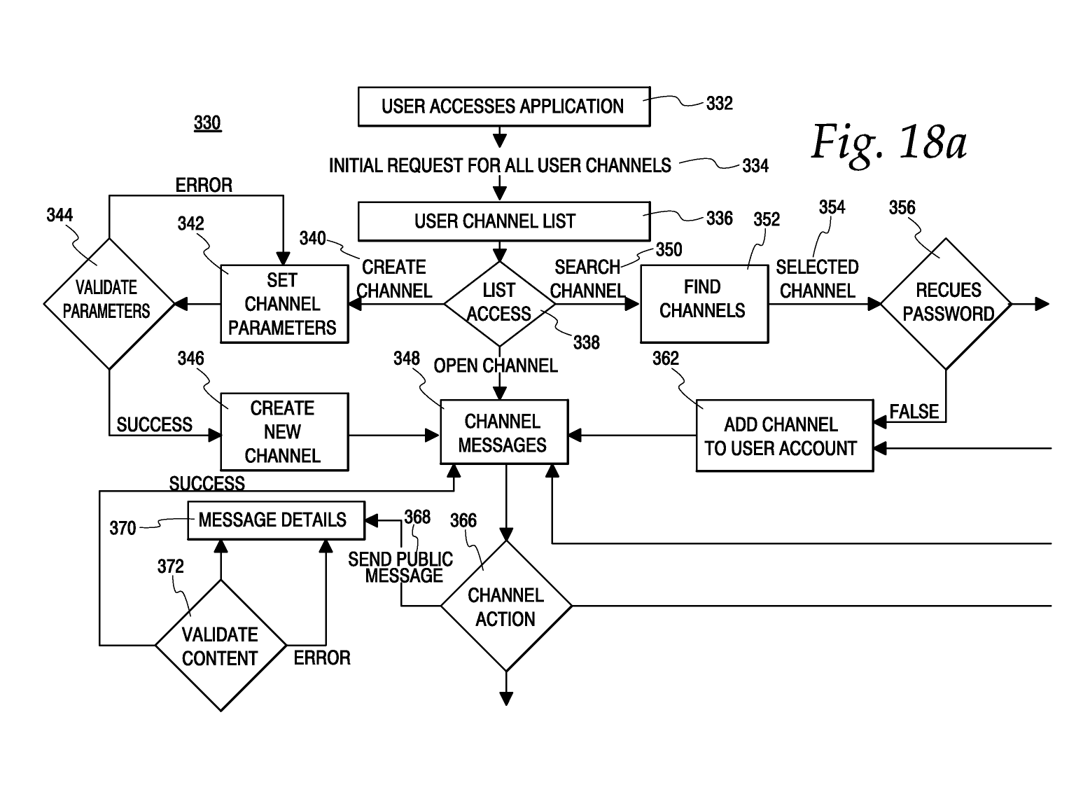

Channel information, FIG. 15, may be accessed at numerous points throughout the flow of the joining a channel process. For example, particular channel information 48 may be selected from the home screen 46, from the join channel screen 286 and from the search results screen 304. Similarly, join channel icons 308 allow the user to join the channel from numerous locations throughout the process. For example, from the join channel screen 286, the search results screen 304 and the channel information screen 296. If the Broadcaster of the particular channel requires a password, the User will be directed to the password screen 310 of FIG. 16 wherein a password will need to be entered in the password box 312 and the join icon 314 selected. The user will then be directed to the Usemame screen 316 wherein he will have the opportunity to provide a Usemame 318 before continuing 320 back to the channel. In any event, once a user joins a particular channel, he becomes a Listener of that channel and will receive messages from that channel's Broadcaster.

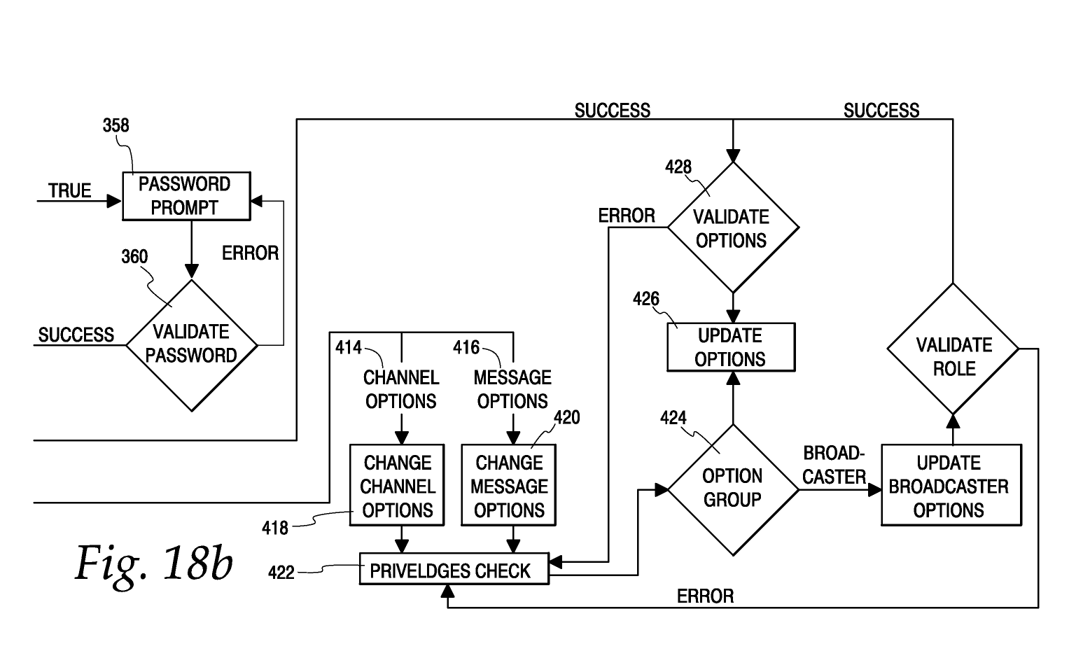

The user of the application is able to access information relative to the application by selecting the About icon 84 from the home screen 46. The about screen 322, FIG. 17, provides the user the opportunity to go back to the onboarding process 324, optional registration 326, and/or various system and administrative options 328.

It will be appreciated that unlike most applications, the application of the present disclosure does not employ a mandatory login or registration feature upon installation in order for a user to join a channel. Instead, the application ties a unique token to a particular PCD. In the event the user gets a new PCD, they simply need to rejoin all of their channels of interest again. Optionally, they can use the system's “optional login” mechanism 326 through the About 84 menu of FIG. 17. This allows the user the option to create an account, and therefor the ability to recover all of their channels should they obtain a new PCD.

Once downloaded and set up on the User's phone, the app is instantly opened and the Broadcaster can type and send small, simple ASCII notifications to their groups. The Broadcaster can send active links that open a browser, attach pre-recorded pictures or video clips as well. Listeners will be alerted/notified via push notifications if any of their subscribed (joined) channels have unread information.

The possible uses of the app has no end. It can be used by small organizations (e.g. principals, teachers, club members, coaches, etc.) or larger companies (e.g. private corporations, sports stations, news stations, etc.) to disseminate and communicate information efficiently, without having to obtain or maintain the end user's (Listener's) contact information. Users can simply add and “tune-in” to any of the “channels” they want to get their announcements from.

By way of example, a second grade teacher can send out a broadcast on her channel informing parents that tomorrow is a minimum day and that the money for next week's field trip is due on Friday. For convenience, she can attach a permission slip to remind parents to sign and return. Similarly, a soccer coach can send out a broadcast on his channel and advise parents where/when the next soccer game is being played and ask for a response from the mom who signed up for snack duty. For fun, he can attach a video clip of the winning shot from last week's soccer match.

The app can be used for social and sporting events by notifications regarding game times, locations, cancellations, reminders, reunions, event coordination, etc. It can be used for education and religious information by notifications regarding classroom news, field trips, reminders, homework, study groups, club announcements, campus emergencies, bible study, church announcements, etc. It can be used for community and government purposes by notifications regarding blackouts, neighborhood watch, buss/trolley times, bulletin board, local police/fire/Amber/news alerts, etc. It can be used for retail and business by notifications regarding coupons/ads, real estate, marketing, corporate announcements, business meetings, restaurants, etc. It is envisioned that further localized or specialized uses will occur. For example, a group chaperone that is taking a group of students on a field trip can use the app to quickly communicate with all of the students at the same time (i.e. “bus will be here at 7 pm”). There are virtually unlimited numbers of markets and social ecosystems in which anonymous mobile group communications system of the present disclosure can be implemented.

It will be appreciated that the flow of the app in use, as previously described, may be altered without deterring from the scope of this disclosure. Such use of the app has been shown and described from both a Broadcaster and a Listener perspective. It has been shown that the iOS and Android app utilizes virtual channels (running on a cloud based service) with databased-driven queries and remote push notifications to allow broadcast text communications that alert user PCD akin to SMS text messaging.

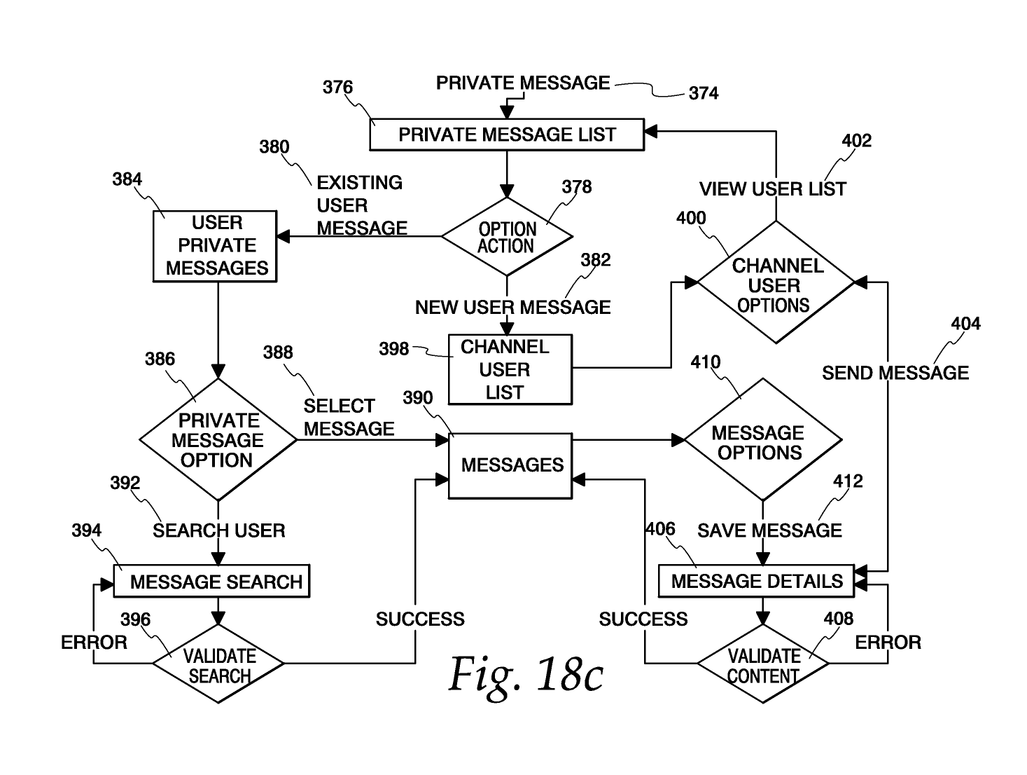

Turning now to FIGS. 18a-c, the backend logic of the system, and the coding (software) by which the app works, will now be briefly described. FIG. 18 shows the software coding flow 330 of the application capable of running on any PCD system platform. The code flow has been written for current major system platforms, specifically the so-called iOS system and the so-called Android system. Furthermore, the backend system uses a service to interface to the Apple Push Notification Service (APNS) and Google Cloud Messaging Service (GCM) to distribute the push notification text messages to the appropriate users in teal-time.

When a user first downloads the application, the backend server creates a unique token or code-word that is used to identify the user and the device they are using. This token is bound by the user's operating system (i.e. Apple iOS, Google Android, etc.) profile so if the application is re-downloaded the token remains the same. The token is preferably derived by an algorithm that uses a physical hardware component (e.g. phone UDID) and a software component as well. This token is used by the backend to retrieve channels, preferences and private/public messages. If the user provides an email address or any other identifying information, it may be encrypted before it is stored in the database.

After initial application download and installation to the user's PCD, FIG. 18 illustrates the backend logic of the system. In particular, when the user accesses application 332, the system performs an initial request 334 for all user channels and provides a listing 336 thereof and waits for user list action 338. Should the user desire to create 340 a channel, the channel parameters are set 342 (including whether the channel will be private, and require a password, or public), validated 344, a new channel created 346, and channel messages 348 are displayed to the user. When a new channel is created a unique code is generated by the system to identify the channel for quick searching. This code is never duplicated and preferably uses a hashing protocol to reduce sequential channel numbers.

When a Broadcaster creates a channel, there is a database that associates the Broadcaster's token with that new “virtual” channel. A virtual channel is basically a new database entry. Initially the database is 1-to-1 since nobody else has yet joined the channel. When users start joining as Listeners to that channel, their token gets added to the distribution list of the new database entry, so that the database becomes a one-to-many type relationship. When the Broadcaster sends a message, the backend system sends a copy of the message to each user (Listener) that is on the distribution list (i.e. each user that has a token associated with that channel). It will be appreciated that should the messages be private (not public), they are only distributed to one particular user.

Turning back to the user list action 338, should the user desire to search 350 for a channel and channels are found 352, then the user selects 354 the desired channel and the system determines whether the selected channel requires a password 356. If it does, there is a password prompt 358 and a subsequent password validation 360 before the channel is added 362 to the user's account and channel messages 348 are displayed. If there is no password requirement, the channel is simply added 362 to the user's account and channel messages 348 are displayed. When a user joins a channel, their token is added to the channel list. If the user removes the channel, the token is kept but flagged as removed. This allows the user to re-join the channel and keep their count. Users with channel tokens flagged as removed will not see the channel in their list or receive any notifications.

Turning once more back to the user list action 338, should the user desire to simply open 364 a channel, that channel's messages 348 are displayed. The system then provides a number of channel actions 366 for the user. For example, a user may send a public message 368 including any number of details 370. Once validated 372, the message is sent and displayed at the channel messages 348. The user may also desire to send a private message 374, in which case a private message list 376 will be displayed and the system will determine the private option action 378 dependent upon whether the private message is to be generated from an existing user 380 or a new user 382. If from an existing user, the system displays the user's private messages 384 and provides the option 386 of either selecting 388 and displaying 390 messages or searching 392 for a user. If the user desires to search, then the system displays 394 and validates 396 the search before displaying 390 any messages.

Referring back to the private option action 378, if from a new user 382, the system displays the channel user list 398 and provides the channel user options 400 of either views 402 the new user list and onto the private message list 376 or send a message 404. If the user is going to send a message, the message details 406 are validated 408 and displayed 390. Once messages are displayed 390 the system provides the messages options 410 for the continued sending 412 of private messages.

Each message sent is sanitized and validated by the system to prevent any cross-site scripting attacks or injection attacks. If a message fails validation the user is prompted about the failure. All messages are stored in a one-too-many relationship database schema. If the channel allows for private messaging the user can create a sub-channel for one on one communication with another channel user. The process creates a new channel record that can be accessed through the parent channel. Private channels cannot be seen by other users in the parent channel. Users are able to search for other user nicknames within the private channel. Finally, users are able to share a channel with their friends/family/contacts via social media or native SMS callbacks. These functions register with the server when called to log channel activity.

Turning back again to where the system provides channel actions 366 for the user. Rather than send messages, the system also allows the user to select channel 414 or message 416 options to either change channel options 418 or change message options 420 respectively. Whichever change is called for, the system will check the user's privileges 422 before proceeding to the option group action 424 where either the Listener (User) options are updated 426 and validated 428 or the Broadcaster options are updated 428 and validated 430 before proceeding to channel messages 348.

It will be appreciated that an application coordinator and/or system host can be a third party and that the account coordinator or system host can receive compensation for acting as the account coordinator or system host. For example, a third party account coordinator or system host can charge Broadcasters a fee per message sent. Alternatively, for example, the app is initially free of charge until after a fixed amount of time, group size, or frequency of messages is achieved. In another alternative example, Listeners are always free to use the app, but the system host will allow Listener purchases within the app.

Broadcasters may want their own channel name, and not a random channel number provided by the system administrator. In such a situation, Broadcasters can be charged a premium for their company name, similar to purchasing a domain name.

Additionally, the app can be used as a supplement/substitute for online purchases between individual buyers and sellers (e.g. Craigslist, etc.). The buyer and seller each open a broadcast channel that they share with one another and then can communicate without ever disclosing their phone numbers. The system host will then manage the transaction and receive a percentage of the transaction as compensation therefore.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present disclosure.

What is claimed is:

1. A system for establishing communication between a transmitter and one or more personal communication devices where the transmitter does not need to know the address or any other identifying indicia of any of the personal communication devices, the system comprising:
a server enabled to establish a designated communication channel which designated channel can be remotely accessed;
a communication device for transmitting information to said designated channel;
one or more personal communication devices capable of receiving information transmitted by the communication device to the designated channel, the one or more personal communication devices having associated identifying indicia unique to the one or more personal communication devices;
an application installed on the one or more personal communication devices, the application permitting selection of the designated channel, the application enabling reception by the one or more personal communication devices of messages transmitted to the designated channel without the system providing the identifying indicia of the one or more personal communication devices to the communication device for transmitting information, and the application providing a signal when a message is transmitted to the designated channel is received by the one or more personal communication devices;
whereby the personal communication device can receive and review messages transmitted to the channel without the transmitter having to know any identifying indicia of a user of the receiving personal communication device.

2. The system of claim 1 wherein the communication device is selected from the group consisting of a personal computer, a mobile phone, and a tablet.

3. The system of claim 1 wherein the application also enables the personal communication device to establishing a designated channel for message transmission.

4. The system of claim 1 wherein the system requires a pass code to receive message transmitted to the designated channel.

5. A mobile group communications system for use with personal communication devices and a network comprising:
a server capable of receiving and transmitting communications through the network;
a database containing information representing each of a plurality of personal communication devices, said database in communication with said server;
a first user personal communication device in communication with said system, said first user personal communication device establishing one or more virtual channels, provided by the system, for broadcasting communications through said network;
a second user personal communication device in communication with said system, said second user personal communication device joining said virtual channel without requiring the user to provide any contact information; and
whereby said first user personal communication device broadcasts a communication through said channel and said second user personal communication device receives said communication.

6. The system of claim 5 wherein the personal communication device is selected from the group consisting of a personal computer, a mobile phone, and a tablet.

7. The system of claim 5 wherein a first user personal communication device is capable of joining one or more channels.

8. The system of claim 5 wherein a second user PCD is capable of establishing one or more channels.

9. The system of claim 5 wherein a channel is joined from the group consisting of a search, a QR code, and a link.

10. A mobile group communications application for use with personal communication devices and a network comprising:
a unique code-word associated with each personal communication device;
a server capable of differentiating multiple users of said application by said code-words;
a database associating said code-word with a channel of communication, said database having a distribution list of multiple code-words for each channel; and
whereby when a personal communication device sends a message on a channel a copy of said message is sent by said server through said network to each code-word on said distribution list.

11. The application as defined in claim 10 wherein said code-word is derived by an algorithm that uses both a physical hardware and a software component.
